(19) United States
(12) Patent Application Publication
(10) Pub. No.: US 2011/0240685 A1
(43) Pub. Date: Oct. 6, 2011

(54) FUEL DISPENSER INCLUDING HOSE MANAGEMENT ARRANGEMENT

(75) Inventors: John E. Ingold, Greensboro, NC (US); Ryan C. Garrett, Randelman, NC (US)

(73) Assignee: GILBARCO INC., Greensboro, NC (US)

(21) Appl. No.: 12/749,788

(22) Filed: Mar. 30, 2010

(51) Int. Cl. B67D 3/00; F16M 13/02; F16L 57/00

(52) U.S. Cl. 222/527; 248/560; 222/526; 138/110; 138/118

(57) ABSTRACT

A hose management arrangement for use with a fuel dispenser having a fuel hose and a fuel nozzle, including a first coupler with a first portion and a second portion, the first coupler being fixed to the fuel hose by the first portion such that a first portion of the fuel hose extends from the first portion of the first coupler to a first end of the fuel hose and a second portion of the fuel hose extends from the first portion of the first coupler to a second end of the fuel hose, and an elongated resilient member including a first end fixed to the first coupler and a second end fixed adjacent the second end of the fuel hose, wherein the second portion of the first coupler slidably receives the second portion of the fuel hose.

### FIELD OF THE INVENTION

The present invention relates generally to fuel dispensers. More particularly, the present invention relates to a fuel dispenser utilizing a hose management arrangement.

### BACKGROUND OF THE INVENTION

Fuel dispensing environments often include multiple fuel dispenser units that include one or more flexible fuel hoses for selectively dispensing fuel that is contained in underground storage tanks. Each fuel hose includes a user-operated nozzle that is positioned within a fill neck of the vehicle receiving the fuel, or other suitable container. Preferably, the fuel hose is of sufficient length to allow the user to dispense fuel into the vehicle regardless of whether the vehicle is positioned such that the fill neck is on the side of the vehicle adjacent the fuel dispenser or on the side of the vehicle that is opposite the fuel dispenser. Additionally, longer fuel hoses increase the overall “range” of the fuel dispenser, meaning persons purchasing the fuel do not have to position the vehicle fill neck as close to the fuel dispenser as would otherwise be the case. Longer fuel hoses also make it less likely that the purchaser may have to reposition his vehicle prior to dispensing fuel. The use of longer fuel hoses also facilitates dispensing fuel to larger vehicles, such as sport utility vehicles, vans, commercial delivery trucks, etc.

Although the use of long fuel hoses is typically desirable, there are a number of drawbacks that can occur due to the extra hose length. As would be expected, the use of long fuel hoses may result in a portion of each fuel hose laying on the ground adjacent the corresponding fuel dispenser. Excess fuel hose on the ground can pose potential difficulties to both the person dispensing the fuel as well as the fuel dispenser itself. For example, the excess fuel hose disposed between the vehicle and the fuel dispenser is something that must be avoided by the person dispensing the fuel. As well, if the fuel hose is run over by the vehicle, equipment damage may occur. In addition to the damage the fuel hose itself may sustain, pressure spikes that occur as the vehicle runs over the fuel hose can result in damage to various hydraulic components within the fuel dispenser. The excess length of the fuel hose laying on the ground often becomes dirty, which is undesirable in that the person dispensing the fuel frequently has to handle that portion of the fuel hose when dispensing fuel to the vehicle.

In an attempt to overcome the noted drawbacks, some existing fuel dispensers include a device to automatically retract any additional length of fuel hose that is not required for fueling operations. For example, various hose retraction systems can include counterweights or spring-loaded pulley systems that allow for the fuel hose to be fully extended, if needed, but retract any excess length of fuel hose within the fuel dispenser when it is not needed. Often, the noted hose retraction systems are disposed within the fuel dispenser and include multiple moving parts. As such, repairs and/or routine maintenance of the retraction system may require access to the interior of the fuel dispenser. As well, as these systems are frequently rather complicated, and the repairs and/or maintenance can be costly. Thus, hose retraction systems may not be appropriate to some emerging markets where cost considerations are significant.

The present invention recognizes and addresses certain or all of the foregoing considerations, and others, of prior art constructions and methods.

### SUMMARY OF INVENTION

According to one aspect, the present invention provides a hose management arrangement for use with a fuel dispenser having a fuel hose and a fuel nozzle. The hose management arrangement includes a first coupler with a first portion and a second portion, the first coupler being fixed to the fuel hose by the first portion of the first coupler such that a first portion of the fuel hose extends from the first portion of the first coupler to a first end of the fuel hose and a second portion of the fuel hose extends from the first portion of the first coupler to a second end of the fuel hose. An elongated resilient member includes a first end fixed to the first coupler and a second end fixed adjacent the second end of the fuel hose. The second portion of the first coupler slidably receives the second portion of the fuel hose such that as the first end of the fuel hose is extended away from the second end of the fuel hose, the second portion of the fuel hose slides through the second portion of the first coupler.

Another aspect of the present invention provides a fuel dispenser including a housing, a fuel hose having a first end and a second end, a fuel nozzle disposed at one of the first end and the second end of the fuel hose, and a hose management arrangement. The hose management arrangement includes a first coupler with a first portion and a second portion, the first coupler being fixed to the fuel hose by the first portion of the first coupler such that a first portion of the fuel hose extends from the first portion of the first coupler to the first end of the fuel hose and a second portion of the fuel hose extends from the first portion of the first coupler to the second end of the fuel hose. An elongated resilient member includes a first end fixed to the first coupler and a second end fixed adjacent the second end of the fuel hose. The second portion of the first coupler is slidably coupled to the second portion of the fuel hose such that as the first end of the fuel hose is extended away from the second end of the fuel hose, the second portion of the first coupler slides along an outer surface at the second portion of the fuel hose.

Another aspect of the present invention provides a hose management arrangement for use with a fuel dispenser including a fuel hose and a fuel nozzle. The hose management arrangement includes a first coupler including a first portion and a second portion, the first portion of the first coupler slidably receiving a first end of the fuel hose and the second portion of the first coupler slidably receiving a second end of the fuel hose such that a portion of the fuel hose disposed between the first portion and second portion of the first coupler forms a loop. A first elongated resilient member includes a first end fixed to the first coupler and a second end fixed adjacent the first end of the fuel hose, and a second elongated resilient member includes a first end fixed to the first coupler and a second end fixed adjacent the second end of the fuel hose. The first portion and the second portion of the first coupler slide along the fuel hose as the first end of the fuel hose is extended away from the second end of the fuel hose.

The accompanying drawings which are incorporated in and constitute a part of this specification, illustrate one or more embodiments of the invention of this application, and together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a perspective view of a fuel dispenser including an embodiment of a hose management arrangement in accordance with the present invention;

FIGS. 2A and 2B are a perspective view and a side view, respectively, of a first coupler of the hose management arrangement of the fuel dispenser shown in FIG. 1;

FIGS. 3A and 3B are a perspective view and a side view, respectively, of a second coupler of the hose management arrangement of the fuel dispenser shown in FIG. 1;

FIGS. 4A and 4B are perspective views of the fuel dispenser shown in FIG. 1, with the fuel hose in extended positions;

FIGS. 5A and 5B are perspective views of the fuel dispenser shown in FIG. 1, including an alternate embodiment of a hose management arrangement in accordance with the present invention;

FIG. 6 is a perspective view of a fuel dispenser including an alternate embodiment of a hose management arrangement in accordance with the present invention;

FIGS. 7A and 7B are perspective views of the fuel dispenser shown in FIG. 6, with the fuel hose in extended positions;

FIGS. 8A and 8B are cross-sectional views of the fuel hose of the fuel dispenser shown in FIGS. 4A and 4B, 5A and 5B, and 7A and 7B taken along lines 8A-8A and 8B-8B, respectively;

FIG. 9 is a perspective view of a fuel dispenser including an alternate embodiment of a hose management arrangement in accordance with the present invention;

FIG. 10 is a perspective view of an alternate embodiment of a first coupler of a hose management arrangement in accordance with the present invention;

FIG. 11 is a perspective view of an alternate embodiment of a second coupler of a hose management arrangement in accordance with the present invention; and

FIGS. 12A and 12B are perspective views of the fuel dispenser shown in FIG. 7 with the fuel hose in extended positions.

Repeat use of reference characters in the present specification and drawings is intended to represent same or analogous features or elements of the inventions according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

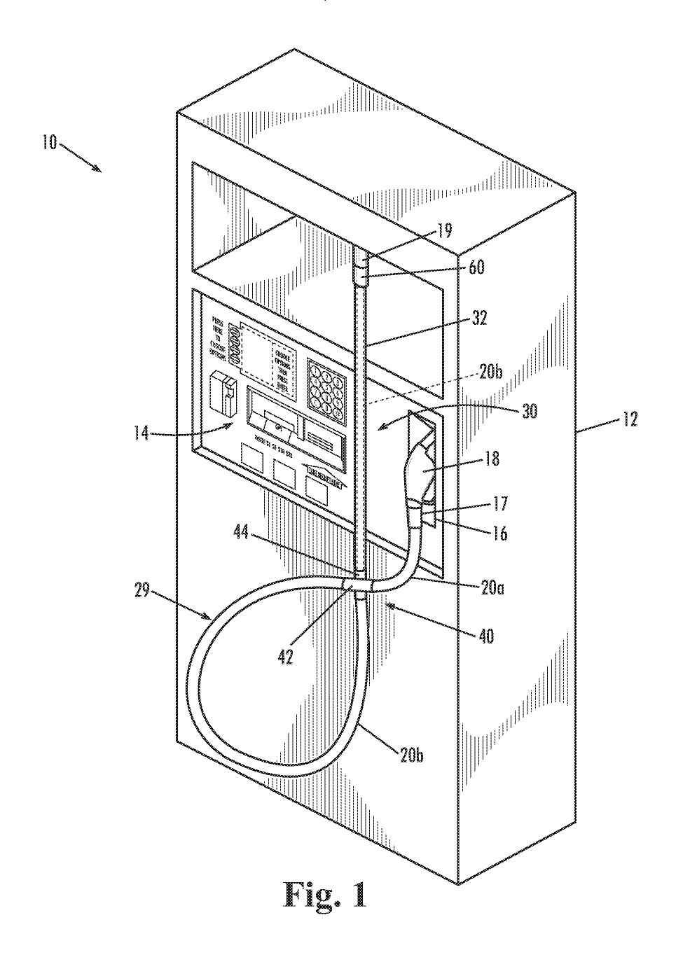

Referring now to the Figures, FIG. 1 shows a fuel dispenser 10 including an embodiment of a hose management arrangement in accordance with the present invention. Fuel dispenser 10 includes a housing 12, a user interface 14, a fuel nozzle 18, a flexible fuel hose having a first portion 20a and a second portion 20b, and hose management arrangement 30. As shown, hose management arrangement 30 includes a first coupler 40, a second coupler 60 and an elongated resilient member 32 extending therebetween, as described in greater detail below.

User interface 14 includes various electronic devices that facilitate the purchase of fuel by the user, such as, but not limited to, a display screen, a keypad, a magnetic card reader, a cash accepter, a receipt printer, and a fuel grade selector, etc. Manually operated fuel nozzle 18 is located as a first end of the fuel hose. Nozzle 18, which rests in boot 16 when not in use, is adapted to be inserted into a fill neck of a vehicle during fueling operations. A second end of the fuel hose is fixed to housing 12 at hose outlet 19. A swivel joint 17 connects fuel nozzle 18 to the fuel hose. Fuel dispenser 10 may be any suitable dispenser, such as those sold by Gilbarco, Inc., of Greensboro, N.C., the assignee of the present invention. Details about the internal operation of a fuel dispenser are described in U.S. Pat. No. 4,978,029, which is hereby incorporated by reference in its entirety for all purposes.

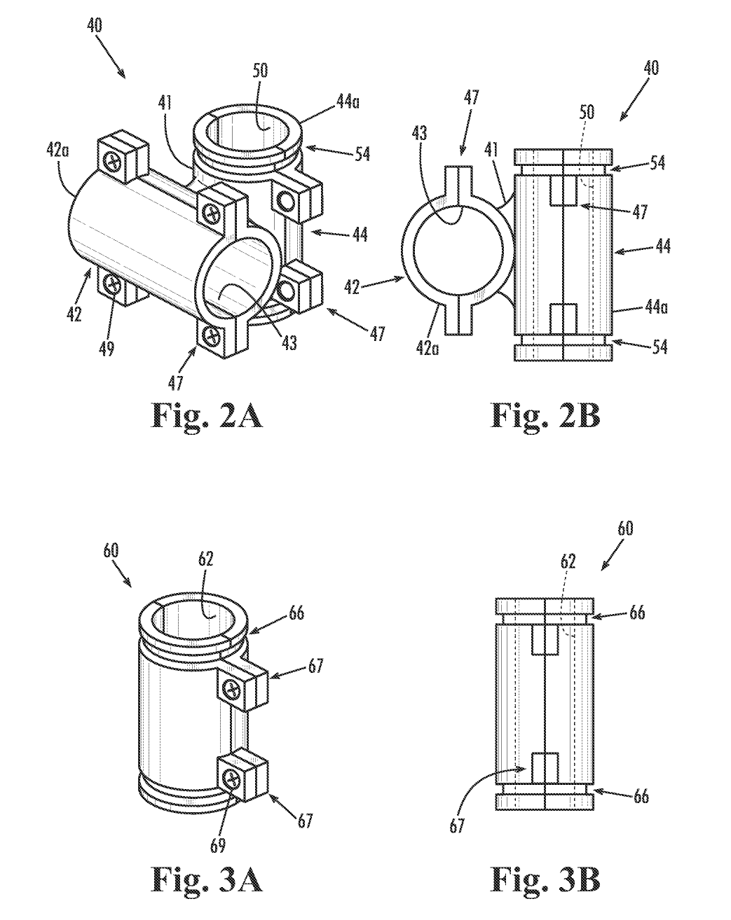

Referring additionally to FIGS. 2A and 2B and FIGS. 3A and 3B, a first embodiment of hose management arrangement in accordance with the present invention is described. Hose management arrangement 30 includes first coupler 40 and second coupler 60 disposed as opposite ends of resilient member 32. In the present embodiment, resilient member 32 is a sleeve comprised of a resilient material, such as, but not limited to, an elastomer or other material with high yield strength, allowing it to significantly lengthen or contract and then return to original dimension without material degradation. As best seen in FIGS. 2A and 2B, first coupler 40 includes first and second portions in the form of tubes 42 and 44. In this embodiment, first tube 42 and second tube 44 are arranged at approximately 90 degrees relative to each other. As shown, a body 41 of first coupler 40 forms half of both first tube 42 and second tube 44. The other half of first tube 42 is formed by semicylindrical element 42a. In particular, element 42a is suitably secured to body 41 (for example, with threaded fasteners 49) to form first tube 42. Similarly, a second semicylindrical element 44a is secured to body 41 with threaded fasteners to form second tube 44. As shown, each threaded fastener 49 is received in a corresponding pair of tabs 47 that extends radially outwardly from the outer surfaces of the corresponding first tube 42 or second tube 44.

Preferably, the inner diameter of first tube 42 of first coupler 40 is slightly less than the outer diameter of the fuel hose on which the hose management arrangement 30 is to be used. As such, when first coupler 40 is secured to the fuel hose by first tube 42, inner surface 43 of first tube 42 grips the fuel hose such that first coupler 40 remains in a fixed position relative to the fuel hose, as discussed in greater detail below. In contrast, the inner diameter of second tube 44 of first coupler 40 is greater than the outer diameter of the corresponding fuel hose. As such, inner surface 50 of second tube 44 is free to slide along the outer surface of the fuel hose during fueling operations. Additionally, a pair of annular grooves 54 is formed on the outer surface of second tube 44 at its opposing ends. Annular grooves 54 are configured to receive a suitable attachment element, such as, but not limited to, an O-ring, a C-clip, a hose clamp, etc., that is used to secure a portion of resilient sleeve 32 to first coupler 40. As one skilled in the art will appreciate, the sleeve could be attached via means other than an annular groove, such as embedding the sleeve or other elongated resilient member into the material of the coupler.

As best seen in FIGS. 3A and 3B, second coupler 60 is preferably a tube formed by two halves. Similar to first coupler 40, the halves of second coupler 60 are secured to each other by threaded fasteners 69 that are received within corresponding pairs of tabs 67 that extend radially outwardly from the outer surfaces of second coupler 60. Similar to first tube 42 of first coupler 40, the inner diameter of second coupler 60 is slightly less than the outer diameter of the fuel hose on which the hose management arrangement 30 is mounted such that second coupler 60 remains in a fixed position relative to the fuel hose once installed. A pair of annular grooves 66 is formed in the outer surface of second coupler 60 at its opposing ends. Annular grooves 66 are configured to receive a suitable attachment element, such as, but not limited to, an O-ring, a C-clip, a radiator clamp, etc., that is used to secure a portion of resilient sleeve 32 to second coupler 60. As with the first coupler, the sleeve could be attached via suitable means other than an annular groove.

As best seen in FIG. 1, first tube 42 of first coupler 40 is used to fix first coupler 40 to the fuel hose, thereby forming a first portion 20a of the fuel hose that extends from first tube 42 of first coupler 40 to fuel nozzle 18 and a second portion 20b of the fuel hose that extends from first tube 42 of the first coupler 40 to hose outlet 19 of fuel dispenser 10. Second portion 20b of the fuel hose is slidably received within second tube 44 of first coupler 40 and sleeve 32, thereby forming a loop 29 in the fuel hose. A first end of resilient sleeve 32 is secured to second tube 44 of first coupler 40 and a second end of resilient sleeve 32 is secured to second coupler 60 adjacent hose outlet 19.

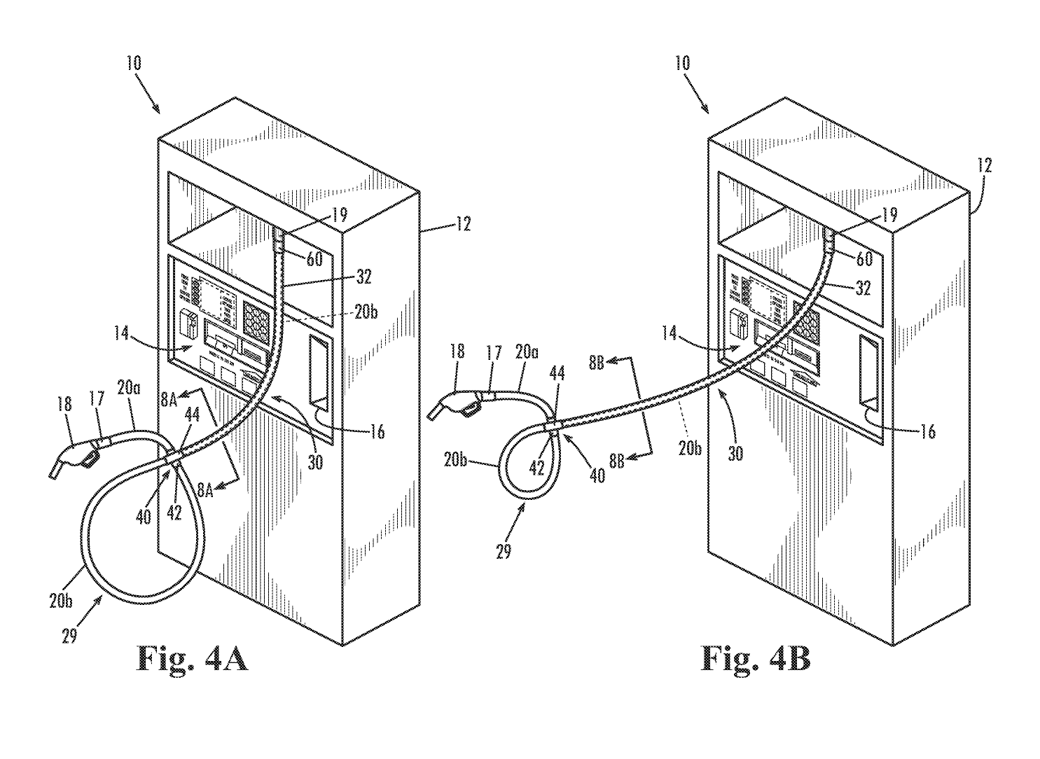

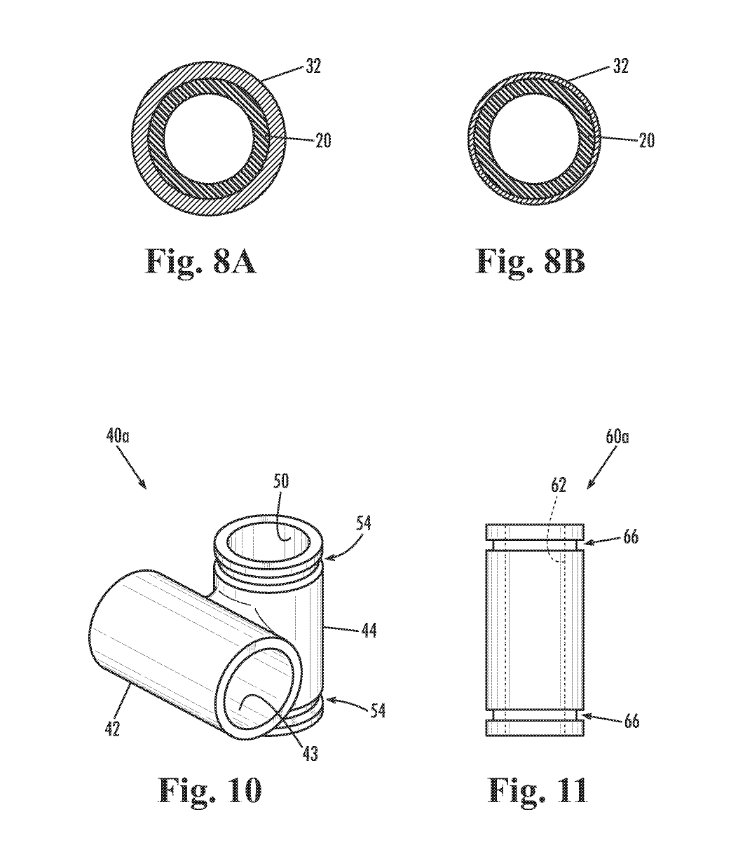

When not in use, fuel nozzle 18 is stored in boot 16 of fuel dispenser 10. As best seen in FIG. 4A, upon the initiation of a fueling operation, a user removes fuel nozzle 18 from boot 16 and extends fuel nozzle 18 toward the fill neck of the vehicle to receive fuel, thereby extending the fuel hose from its at-rest position. As best seen in FIG. 4B, as the user continues to extend fuel nozzle 18 toward the vehicle, the pulling force exerted by the user causes second tube 44 of first coupler 40 to slide along second portion 20b of the fuel hose against the opposing biasing force of resilient sleeve 32. As such, loop 29 formed by second portion 20b of the fuel hose becomes smaller. Note, the length of first portion 20a of the fuel hose disposed between fuel nozzle 18 and first coupler 40 remains constant since first coupler 40 is non-slidably fixed to the fuel hose by first tube 42. As shown in FIG. 8B, the wall thickness of resilient sleeve 32 becomes thinner, as opposed to its wall thickness in the at-rest position (FIG. 8A), as the overall length of resilient sleeve 32 increases.

Upon completion of the fueling operation, the user removes fuel nozzle 18 from the vehicle and returns it to boot 16 of fuel dispenser 10. As best seen in FIG. 4A, as fuel nozzle 18 is moved toward fuel dispenser 10 by the user, resilient sleeve 32 returns to its at-rest length, thereby exerting a biasing force on first coupler 40. As such, second tube 44 of first coupler 40 slides inwardly toward dispenser 10 along second portion 20b of the fuel hose, and loop 29 returns to its at-rest size such that excess hose length is maintained in an orderly fashion when not in use.

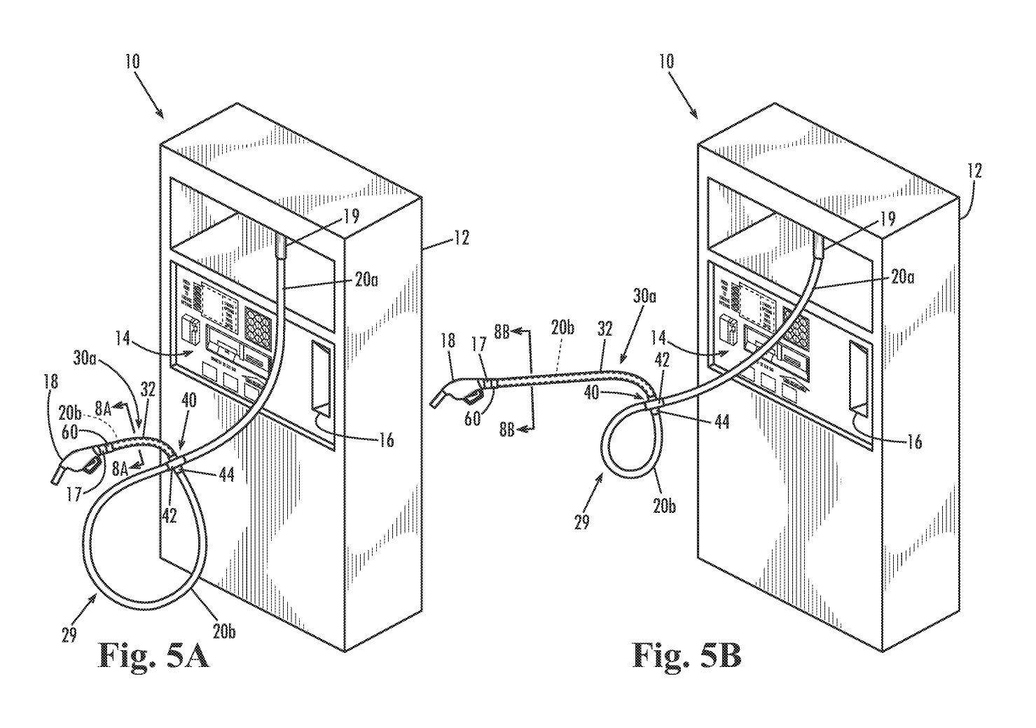

Referring now to FIGS. 5A and 5B, an alternate embodiment of a hose management arrangement 30a in accordance with the present invention is described. As shown, the present embodiment of hose management arrangement 30a includes first coupler 40 (FIGS. 2A and 2B), second coupler 60 (FIGS. 3A and 3B), and resilient sleeve 32, each of which has been previously discussed. As such, a detailed description of each component is not repeated here. First tube 42 of first coupler 40 is used to fix first coupler 40 to the fuel hose thereby forming a first portion 20a of the fuel hose that extends from first tube 42 of first coupler 40 to hose outlet 19 of fuel dispenser 10 and a second portion 20b of the fuel hose that extends from first tube 42 of first coupler 40 to fuel nozzle 18. Second portion 20b of the fuel hose is slidably received in second tube 44 of first coupler 40 and resilient sleeve 32, thereby forming a loop 29 in the fuel hose. A first end of resilient sleeve 32 is secured to second tube 44 of first coupler 40 and a second end of resilient sleeve 32 is secured to second coupler 60 adjacent fuel nozzle 18.

When not in use, fuel nozzle 18 is stored in boot 16 of fuel dispenser 10. As best seen in FIG. 5A, upon the initiation of a fueling operation, a user removes fuel nozzle 18 from boot 16 and extends fuel nozzle 18 toward the fuel neck of the vehicle to receive fuel, thereby extending the fuel hose from its at-rest position. As best seen in FIG. 5B, as the user continues to extend fuel nozzle 18 toward the vehicle, the pulling force exerted by the user causes second tube 44 of first coupler 40 to slide along second portion 20b of the fuel hose against the opposing biasing force of resilient sleeve 32. As such, loop 29 formed by second portion 20b of the fuel hose becomes smaller. Note, the length of or portion 20a of the fuel hose disposed between first coupler 40 and hose outlet 19 of fuel dispenser 10 remains constant since first coupler 40 is non-slidably fixed to the fuel hose by first tube 42. As shown in FIG. 8B, the wall thickness of resilient sleeve 32 becomes thinner, as compared to its wall thickness in the at-rest position (FIG. 8A), as the overall length of resilient sleeve 32 increases.

Upon completion of the fueling operation, the user removes fuel nozzle 18 from the vehicle and returns it to boot 16 of fuel dispenser 10. As best seen in FIG. 5A, as fuel nozzle 18 is moved toward fuel dispenser 10 by the user, resilient sleeve 32 returns it its at-rest length, thereby exerting a biasing force on first coupler 40. As such, second tube 44 of first coupler 40, slides toward fuel nozzle 18 along second portion 20b of the fuel hose, and loop 29 returns to its at-rest size such that excess hose length is maintained in an orderly fashion when not in use.

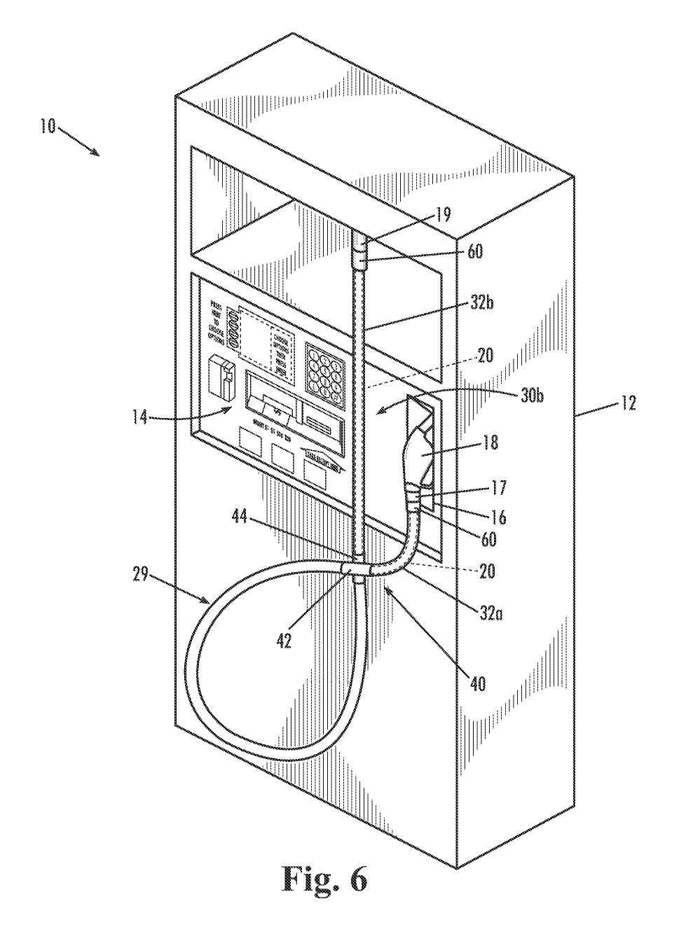

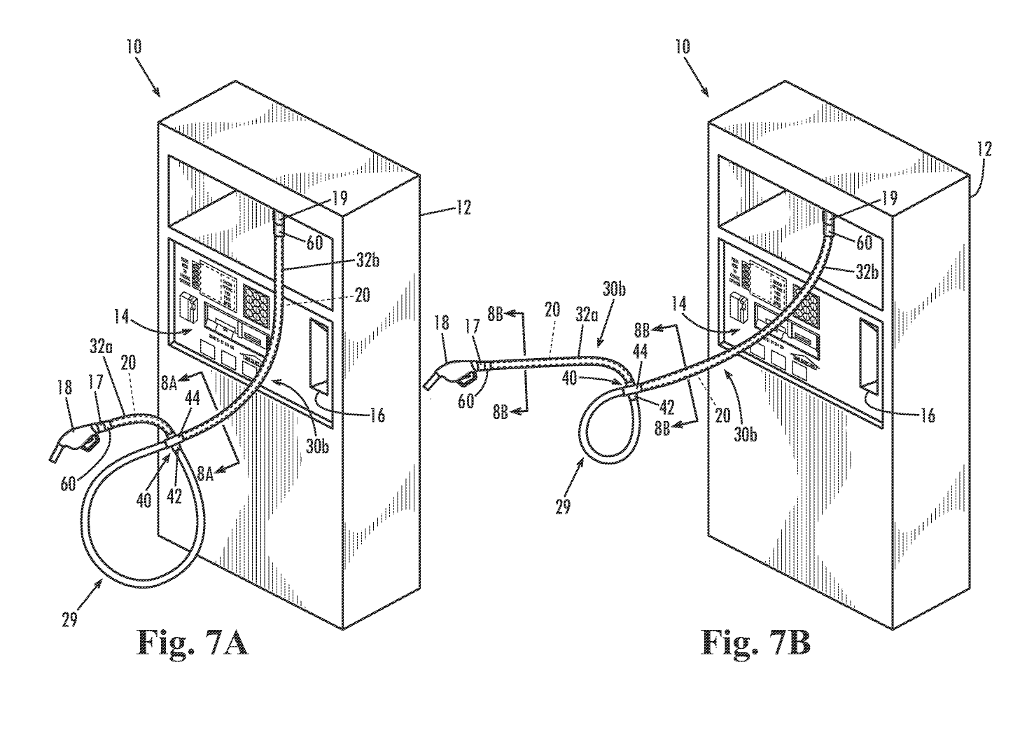

Referring now to FIGS. 6, 7A and 7B, an alternate embodiment of a hose management arrangement 30b in accordance with the present invention is described. As shown, the present embodiment of hose management arrangement 30b includes a first coupler 40, a pair of second couplers 60 (FIGS. 3A and 3B), and a pair of resilient sleeves 32a and 32b. Second couplers 60 and resilient sleeves 32a and 32b have been previously discussed. As such, a detailed description of each component is not repeated here. First coupler 40 of the present embodiment differs from that shown in FIGS. 2A and 2B in that an additional pair of annular grooves is formed on the outer surface of first tube 42 at its opposing ends, and the inner diameter of first tube 42 is greater than the outer diameter of the corresponding fuel hose, similar to the inner diameter of second tube 44. As such, both inner surface 43 of first tube 42 and inner surface 50 of second tube 44 are free to slide along the outer surface of the fuel hose.

As shown, a first end of fuel hose 20 is slidably received within first tube 42 of first coupler 40 and sleeve 32a, the first end of fuel hose 20 terminating at fuel nozzle 18. A first end of resilient sleeve 32a is secured to first tube 42 of first coupler 40 and a second end of resilient sleeve 32a is secured to second coupler 60 adjacent fuel nozzle 18. A second end of fuel hose 20 is slidably received within second tube 44 of first coupler 40 and sleeve 32b, thereby forming a loop 29 in the fuel hose. A first end of resilient sleeve 32b is secured to second tube 44 of first coupler 40 and a second end of resilient sleeve 32b is secured to second coupler 60 adjacent hose outlet 19.

When not in use, fuel nozzle 18 is stored in boot 16 of fuel dispenser 10. As best seen in FIG. 7A, upon the initiation of a fueling operation, the user removes fuel nozzle 18 from boot 16 and extends fuel nozzle 18 toward the fuel neck of the vehicle to receive fuel, thereby extending the fuel hose from its at-rest position. As best seen in FIG. 7B, as the user continues to extend fuel nozzle 18 toward the vehicle, the pulling force exerted by the user causes both first tube 42 and second tube 44 of first coupler 40 to slide along the fuel hose against the opposing biasing force of resilient sleeves 32a and 32b, respectively. As such, loop 29 formed by the fuel hose becomes smaller. As shown in FIG. 8B, the wall thicknesses of resilient sleeves 32a and 32b become thinner, as compared to the wall thicknesses in the at-rest position (FIG. 8A), as the overall lengths of resilient sleeves 32a and 32b increase.

Upon completion of the fueling operation, the user removes fuel nozzle 18 from the vehicle and returns it to boot 16 of fuel dispenser 10. As best seen in FIG. 7A, as fuel nozzle 18 is moved toward fuel dispenser 10 by the user, resilient sleeves 32a and 32b return to their at-rest lengths, thereby exerting biasing forces of first coupler 40. As such, first tube 42 and second tube 44 of first coupler 40 slide toward fuel nozzle 18 and hose outlet 19, respectively, along the fuel hose, and loop 29 returns to its at-rest size such that excess hose length is maintained in an orderly fashion when not in use.

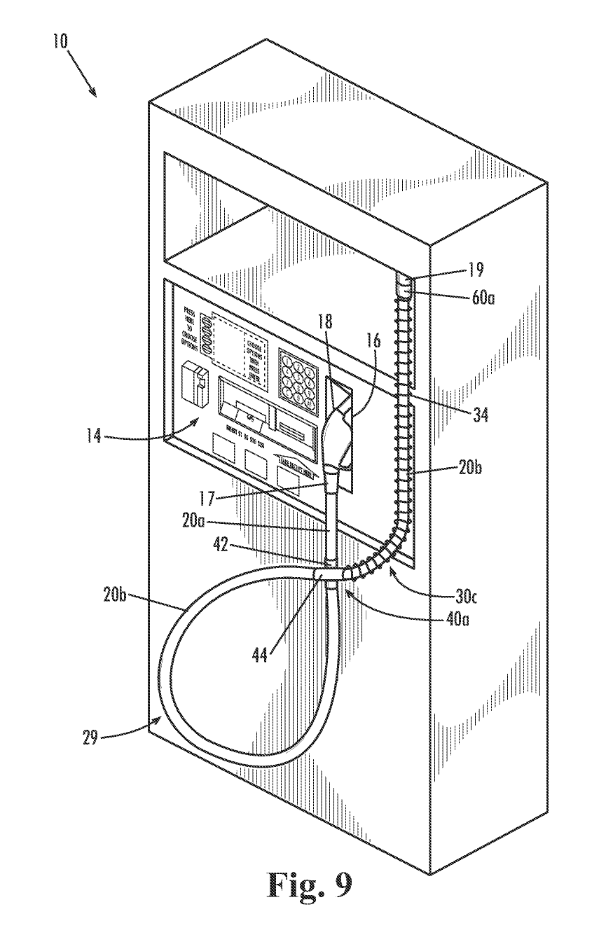

Referring now to FIG. 9, an alternate embodiment of a hose management arrangement 30c in accordance with the present invention is described. As shown, the present embodiment of hose management arrangement 30c includes a first coupler 40a, a second coupler 60a and an elongated resilient member 34 extending therebetween. As best seen in FIG. 10, first coupler 40a includes a first tube 42 and a second tube 44 that are arranged at approximately 90 degrees relative to each other. Preferably, the inner diameter of first tube 42 of first coupler 40a is slightly less than the outer diameter of the fuel hose on which hose management arrangement 30c is to be used. As such, when first coupler 40a is installed on the fuel hose by first tube 42, inner surface 43 of first tube 42 grips the fuel hose in a friction fit such that first coupler 40a remains in a fixed position. In an alternate embodiment, the inner diameter of first tube 42 can be substantially the same as the outer diameter of the corresponding fuel hose. In such an embodiment, a suitable adhesive can be used to adhere inner surface 43 of first tube 42 to the outer surface of the fuel hose.

In contrast, the inner diameter of second tube 44 of first coupler 40a is greater than the outer diameter of the corresponding fuel hose. As such, the inner surface 50 of second tube 44 is free to slide along the outer surface of the fuel hose during fueling operations. Additionally, a pair of annular grooves 54 is formed on the outer surface of second tube 44 at its opposing ends. Annular grooves 54 are configured to receive a suitable attachment element, such as, but not limited to, an O-ring, a C-clip, a hose clamp, etc., that is used to secure a portion of resilient member 34 to first coupler 40a. In the present embodiment, resilient member 34 is a coil spring comprised of a suitable metal, such as, but not limited to, steel (ferrous) or non-ferrous alloys. Additionally, in yet another alternate embodiment, the resilient member can be one or more cords comprised of an elastic material, such as, but not limited to, an elastomer or other material with high yield strength, allowing it to significantly lengthen or contract and then return to original dimension without material degradation.

Referring now to FIG. 11, the inner diameter of second coupler 60a is preferably less than the outer diameter of the fuel hose on which hose management device 30c is mounted. As such, when second coupler 60a is installed on the fuel hose, inner surface 62 grips the fuel hose in a friction fit such that second coupler 60a remains in a fixed position relative to the fuel hose. In an alternate embodiment, the inner diameter of second coupler 60a can be substantially the same as the outer diameter of the corresponding fuel hose. In such an embodiment, a suitable adhesive can be used to adhere inner surface 62 of second coupler 60a to the outer surface of the fuel hose. A pair of annular grooves 66 is formed in the outer surface of second coupler 60a at its opposing ends. Annular grooves 66 are configured to receive a suitable attachment element, such as, but not limited to, an O-ring, a C-clip, a typical hose clamp, etc., that is used to secure a portion of coil spring 34 to second coupler 60a.

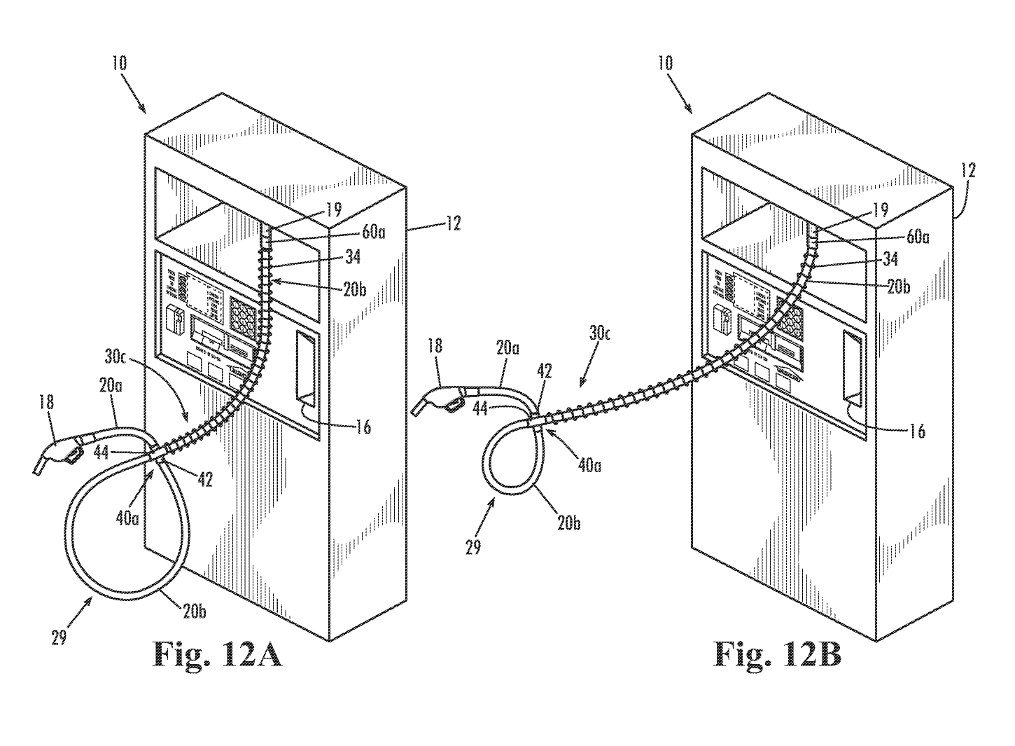

As best seen in FIGS. 12A and 12B, hose management arrangement 30c performs in substantially the same manner as does hose management device 30 that is previously discussed with regard to FIGS. 1, 4A and 4B. As such, a complete description of the operation of hose management arrangement 30c is not required and, therefore, not repeated here. Note, however, the primary difference with regard to the previously discussed hose management arrangement 30 is that hose management arrangement 30c includes coil spring 34 as the resilient member rather than a resilient sleeve 32 (FIG. 1).

It can thus be seen that the present invention provides a novel hose management arrangement for use with a fuel dispenser. While the hose management arrangement has been described for use with a fuel dispenser, aspects of the present invention may be applicable to other types of dispensers, or other situations where hose management is desirable.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole and in part. Furthermore, those of ordinary skill in the art will appreciate that the foregoing description is by way of example only, and is not intended to limit the invention so further described in such appended claims. Therefore, the spirit and scope of the appended claims should be limited to the description of the preferred versions contained therein.

What is claimed is:

1. A hose management arrangement for use with a fuel dispenser including a fuel hose and a fuel nozzle, comprising:
a first coupler including a first portion and a second portion, the first coupler being fixed to the fuel hose by the first portion of the first coupler such that a first portion of the fuel hose extends from the first portion of the first coupler to a first end of the fuel hose and a second portion of the fuel hose extends from the first portion of the first coupler to a second end of the fuel hose; and
an elongated resilient member including a first end fixed to the first coupler and a second end fixed adjacent the second end of the fuel hose,
wherein the second portion of the first coupler slidably receives the second portion of the fuel hose such that as the first end of the fuel hose is extended away from the second end of the fuel hose, the second portion of the fuel hose slides through the second portion of the first coupler.

2. The hose management arrangement of claim 1, wherein the second end of the resilient member is disposed adjacent a portion of the fuel dispenser.

3. The hose management arrangement of claim 1, wherein the second end of the resilient member is disposed adjacent the fuel nozzle.

4. The hose management arrangement of claim 1, further comprising a second coupler fixed adjacent the second end of the fuel hose, wherein the second end of the resilient member is fixed to the second coupler and the first end of the resilient member is fixed to the second tube of the first coupler.

5. The hose management arrangement of claim 1, wherein the resilient member further comprises a resilient sleeve that is disposed about the second portion of the fuel hose.

6. The hose management arrangement of claim 1, wherein the resilient member further comprises a resilient cord coiled around the second portion of the fuel hose.

7. The hose management arrangement of claim 1, wherein the resilient member further comprises a coiled spring that is coiled about an outer surface of the second portion of the fuel hose.

8. The hose management arrangement of claim 1, wherein the fuel nozzle is disposed at the first end of the fuel hose and the second end of the fuel hose is disposed adjacent the fuel dispenser.

9. The hose management arrangement of claim 1, wherein the fuel nozzle is disposed at the second end of the fuel hose and the first end of the fuel hose is disposed adjacent the fuel dispenser.

10. The hose management arrangement of claim 1, wherein the first portion and the second portion of the first coupler further comprise a first tube and a second tube, respectively.

11. The hose management arrangement of claim 1, wherein a longitudinal center axis of the first tube is oriented at an angle of approximately 90 degrees with respect to a longitudinal center axis of the second tube.

12. A fuel dispenser, comprising:
a housing;
a fuel hose having a first end and a second end;
a fuel nozzle disposed at one of the first end and the second end of the fuel hose;
a hose management arrangement, comprising:
a first coupler including a first portion and a second portion, the first coupler being fixed to the fuel hose by the first portion of the first coupler such that a first portion of the fuel hose extends from the first portion of the first coupler to the first end of the fuel hose and a second portion of the fuel hose extends from the first portion of the first coupler to the second end of the fuel hose; and
an elongated resilient member including a first end fixed to the first coupler and a second end fixed adjacent the second end of the fuel hose,
wherein the second portion of the first coupler is coupled to the second portion of the fuel hose such that as the first end of the fuel hose is extended away from the second end of the fuel hose, the second portion of the first coupler slides along an outer surface at the second portion of the fuel hose.

13. The fuel dispenser of claim 12, wherein the fuel nozzle is disposed at the first end of the fuel hose and the second end of the resilient member is disposed adjacent a portion of the fuel dispenser.

14. The fuel dispenser of claim 12, wherein the second end of the resilient member is disposed adjacent the fuel nozzle at the second end of the fuel hose and the first end of the fuel hose is disposed adjacent the housing of the fuel dispenser.

15. The fuel dispenser of claim 12, wherein the hose management arrangement further comprises a second coupler fixed adjacent the second end of the fuel hose, and the second end of the resilient member is fixed to the second coupler and the first end of the resilient member is fixed to the second tube of the first coupler.

16. The fuel dispenser of claim 12, wherein the resilient member of the hose management arrangement further comprises one of a resilient sleeve that is disposed about the second portion of the fuel hose, a resilient cord coiled around the second portion of the fuel hose, and a coiled spring that is coiled about an outer surface of the second portion of the fuel hose.

17. The fuel dispenser of claim 12, wherein the fuel nozzle is disposed at the first end of the fuel hose and the second end of the fuel hose is disposed adjacent the housing of the fuel dispenser.

18. The fuel dispenser of claim 12, wherein the fuel nozzle is disposed at the second end of the fuel hose and the first end of the fuel hose is disposed adjacent the housing of the fuel dispenser.

19. A hose management arrangement for use with a fuel dispenser including a fuel hose and a fuel nozzle, comprising:
a first coupler including a first portion and a second portion, the first portion of the first coupler slidably receiving a first end of the fuel hose and the second portion of the first coupler slidably receiving a second end of the fuel hose such that a portion of the fuel hose disposed between the first portion and second portion of the first coupler forms a loop;
a first elongated resilient member including a first end fixed to the first coupler and a second end fixed adjacent the first end of the fuel hose; and
a second elongated resilient member including a first end fixed to the first coupler and a second end fixed adjacent the second end of the fuel hose,
wherein the first portion and the second portion of the first coupler slide along the fuel hose as the first end of the fuel hose is extended away from the second end of the fuel hose.

20. The hose management arrangement of claim 19, wherein the second end of the second resilient member is disposed adjacent a portion of the fuel dispenser and the second end of the first resilient member is disposed adjacent the fuel nozzle.

21. The hose management arrangement of claim 19, wherein the loop formed by fuel hose becomes smaller as the first end of the fuel hose is extended away from the second end of the fuel hose.

22. The hose management arrangement of claim 19, wherein each of the first and second resilient members further comprises a resilient sleeve that is disposed about the fuel hose.

23. The hose management arrangement of claim 19, wherein the fuel nozzle is disposed at the first end of the fuel hose and the second end of the fuel hose is disposed adjacent the fuel dispenser.
